(19) United States
(12) Patent Application Publication
(10) Pub. No.: US 2025/0320762 A1
(43) Pub. Date: Oct. 16, 2025

(54) VEHICLE DOOR SYSTEM AND SENSOR DEVICE FOR A VEHICLE DOOR SYSTEM

(71) Applicants: Brose Fahrzeugteile SE & Co. Kommanditgesellschaft, Bamberg, Bamberg (DE); BODE - DIE TÜR GMBH, Kassel (DE)

(72) Inventors: Markus ROSENTHAL, Bamberg (DE); Christian GITTER, Zeil am Main (DE); Sergej GAUERHOF, Knetzgau (DE); Dalibor RIETDIJK, Wetzlar (DE)

(73) Assignees: Brose Fahrzeugteile SE & Co. Kommanditgesellschaft, Bamberg, Bamberg (DE); BODE - DIE TÜR GMBH, Kassel (DE)

(21) Appl. No.: 17/769,214

(22) PCT Filed: Oct. 15, 2020
(86) PCT No.: PCT/EP2020/079006

§ 371 Date: Jun. 6, 2024

(30) Foreign Application Priority Data
Oct. 15, 2019 (DE) 10 2019 127 732.9

(51) Int. Cl. E05F 15/646; E05F 17/00

(52) U.S. Cl. CPC E05F 15/646; E05F 17/004; E05Y 2201/654; E05Y 2400/415; E05Y 2900/506

(57) ABSTRACT

A vehicle door element (120, 122) for reversibly closing at least part of a body opening (102) on a vehicle (100) comprises a door leaf (124, 126) and at least one guide arm (128, 130, 132, 134) which includes a door-side portion and a vehicle-side portion, wherein the door-side portion of the guide arm (128, 130, 132, 134) is mounted on the door leaf (124, 126), and the vehicle-side portion of the guide arm (128, 130, 132, 134) includes connecting means (140, 142, 144, 146) which are configured for shiftably connecting the vehicle door element (120, 122) to the vehicle (100). The connecting means (140, 142, 144, 146) comprise at least one first connecting means (140, 142) which is configured for shiftable connection to a first guide rail (150, 152) of a vehicle door system (110) of the vehicle (100), and at least one second connecting means (144, 146) which is configured for shiftable connection to a second guide rail (154, 156) of the vehicle door system (110) of the vehicle (100). A sensor device (500) for a vehicle door system (110) comprises a sensor unit (510), an adjusting device (520), and a control unit (530) which is configured to control the adjusting device (520) in dependence on the position of at least one vehicle door element (120, 122) of the vehicle door system (110).

The present invention generally relates to the field of vehicle entries. In particular, it relates to a vehicle door element for reversibly closing at least part of a body opening on a vehicle, wherein the vehicle door element is configured for shiftable connection to the vehicle. Furthermore, it relates to a vehicle door system, a sensor device for a vehicle door system, a passenger transport system and a method for operating a sensor device for a vehicle door system.

Various techniques for providing vehicle access are known. On buses, for example, one or more of three different door types conventionally are used, i.e. inward swinging doors, swinging sliding doors and outward swinging doors. These door types, however, have disadvantages in use on so-called people movers, i.e. passenger transport systems which often are employed driverless and over shorter distances. The described doors occupy relatively much installation space within the passenger cell, which often anyway already is relatively small, and they also include a visible door mechanism. Moreover, its automatic operation requires relatively much energy. This partly results from the relatively high weight of the doors and their operation sometimes effected by means of several electric motors.

Therefore, vehicle door systems with shiftable door elements often are used in the described passenger transport systems. As such passenger transport systems are usually operated without operating personnel, simple forms in the equipment are preferred both for passenger protection and to avoid targets of wanton damage. Vehicle doors often are designed as flat sliding doors without any protruding parts. There is often provided a sensor system which monitors hazardous areas, such as the travel path of automatic vehicle doors, for possible objects and people inside. The shiftable door elements often are driven by means of several drives, one of which for example is attached to an upper region of the door element and another one is attached to a lower region of the door element and which are in a master-slave relationship to each other, in which a setpoint position for example of the drive in the lower region is determined with reference to a detected adjustment position of the drive in the upper region.

Because of the necessary travel path of the door elements, the known vehicle door systems comprising shiftable doors often involve limitations in use on passenger transport systems with a small wheelbase. These limitations also exist where the travel path of the vehicle doors extends along the outside of the vehicle. Thus, there might also be the possibility of a collision of the door with the wheel when the wheels are turned in. Said limitation exists in particular in passenger transport systems on which all wheels are steerable. Complicated kinematics for vehicle doors, on the other hand, make suitable sensor technology for hazard detection difficult. In drives having a master-slave relationship disadvantages often result from a non-uniform load distribution between the drives due to a time delay resulting from the signal generation for the slave drive.

Therefore, what is desirable is a technique which mitigates or avoids the aforementioned disadvantages.

According to a first aspect, there is described a vehicle door element for reversibly closing at least part of a body opening on a vehicle. The vehicle door element comprises a door leaf and at least one guide arm which includes a door-side portion and a vehicle-side portion, wherein the door-side portion of the guide arm is mounted on the door leaf and the vehicle-side portion of the guide arm includes connecting means which are configured for the shiftable connection of the vehicle door element to the vehicle. The connecting means comprise at least one first connecting means which is configured for shiftable connection to a first guide rail of a vehicle door system of the vehicle, and at least one second connecting means which is configured for shiftable connection to a second guide rail of the vehicle door system of the vehicle.

The guide arm can be rigid with respect to the door leaf. The first connecting means and the second connecting means can be spaced apart from each other along a direction of displacement of the vehicle door element.

In the region of the first connecting means, the guide arm can extend parallel to the direction of displacement beyond a boundary of the door leaf. In the region of the first connecting means, the guide arm can extend in a closing direction of the vehicle door element beyond the boundary of the door leaf.

The vehicle door element can comprise two guide arms which are arranged on opposite sides of the door leaf.

According to another aspect, a vehicle door system is described. The vehicle door system comprises at least one vehicle door element of the type described here, and at least one first guide rail for shiftable connection to a first connecting means of the vehicle door element and at least one second guide rail for shiftable connection to a second connecting means of the vehicle door element. The first guide rail extends at least substantially parallel to a direction of displacement of the vehicle door element. The second guide rail includes at least one portion non-parallel to the direction of displacement.

The first connecting means can comprise a carriage which is shiftably arranged on the first guide rail.

Furthermore, the vehicle door system can comprise at least one drive with at least one Bowden cable, wherein the Bowden cable is attached to the carriage.

The vehicle door system can comprise at least two vehicle door elements which are arranged with opposite closing directions. Additionally or alternatively, the vehicle door system can comprise at least two drives, each of which is provided for automatically moving the guide arm or the guide arms each on one of the opposite sides of the door leaf. The at least two drives can be operable in a synchronized way, in particular by means of a master-slave relationship between the drives and/or by means of a position sensor system in combination with a correction control with respect to at least one of the drives.

In the closed position of the vehicle door elements, guide arms which are associated to different vehicle door elements and which are arranged on the same side of the respective door leaf with respect to the body opening can overlap each other.

The drive can be configured to drive the carriages of several guide arms, which are arranged on the same side with respect to the body opening, at the same time.

The vehicle door system can comprise at least one sensor device. The sensor device can comprise a sensor unit which includes a directional detection area and is configured to detect the presence of an object in the detection area, and an adjusting device which is arranged on the sensor unit and is configured to adjust a position of the sensor unit in such a way that an orientation of the detection area of the sensor unit thereby is changed. The sensor device furthermore can comprise a control unit which is configured to control the adjusting device in dependence on the position of the vehicle door element.

According to another aspect, there is described a sensor device for a vehicle door system. The sensor device comprises a sensor unit which includes a directional detection area and is configured to detect the presence of an object in the detection area, and an adjusting device which is arranged on the sensor unit and is configured to adjust a position of the sensor unit in such a way that an orientation of the detection area of the sensor unit is changed. The sensor device furthermore comprises a control unit which is configured to control the adjusting device in dependence on the position of at least one vehicle door element of the vehicle door system.

The sensor unit and the adjusting device can be configured for arrangement on the vehicle door element. The control unit can be configured to control the adjusting device in such a way that in a closed position and/or in a completely open position of the vehicle door element the sensor unit is in a recessed position in the vehicle door element.

The vehicle door system can be configured such that the vehicle door element is shiftable between a closed position and a completely open position along a non-linear travel path. The control unit can be configured to control the adjusting device in such a way that the detection area of the sensor unit comprises a hazardous area variable corresponding to the travel path in dependence on the position of the vehicle door element.

The control unit furthermore can be configured to determine a position of the detection area with respect to the vehicle door system in dependence on the position of the vehicle door element.

According to another aspect, there is described a passenger transport system. The passenger transport system comprises a vehicle door element, a vehicle door system and/or a sensor device of the type each presented here.

According to another aspect, there is described a method for operating a sensor device for a vehicle door system. The vehicle door system comprises a sensor unit which includes a directional detection area and is configured to detect the presence of an object in the detection area, and an adjusting device which is arranged on the sensor unit and is configured to adjust a position of the sensor unit in such a way that an orientation of the detection area of the sensor unit is changed, and a control unit which is configured to control the adjusting device in dependence on the position of at least one vehicle door element of the vehicle door system.

The method comprises determining, by means of the control unit, a position of the vehicle door element, generating, by means of the control unit and in dependence on the determined position of the vehicle door element, a control signal for controlling the adjusting device, and outputting, by means of the control unit, the control signal to the adjusting device.

According to another aspect, there is described another vehicle door system for reversibly closing a body opening on a vehicle. The vehicle door system comprises at least one vehicle door element and a drive device with at least one first drive and at least one second drive for automatically moving the vehicle door element between an open position and a closed position of the vehicle door element. The vehicle door system also comprises a control device which is configured to control the drive device according to a master-slave relationship in such a way that the second drive at least partly is controlled on the basis of an assumed adjustment position of the first drive, wherein the assumed adjustment position of the first drive is composed at least of a determined adjustment position of the first drive and a stored position offset. The position offset has a magnitude variable in dependence on a position of the vehicle door element.

The position of the vehicle door element can be related to a point in a region between the closed position and the open position of the vehicle door element and/or a travel path of the vehicle door element.

The magnitude of the position offset in relation to a travel path of the vehicle door element can be variable in such a way that an amount of the position offset is smaller in an initial region of the travel path than in at least one further region of the travel path. The initial region of the travel path can comprise the closed position or the open position of the vehicle door element. The amount of the position offset in the closed position or in the open position of the vehicle door element can be zero in the initial region.

The magnitude of the position offset in relation to a travel path of the vehicle door element can be variable in such a way that an amount of the position offset is smaller in an end region of the travel path than in at least one further region of the travel path. The end region of the travel path can comprise the open position or the closed position of the vehicle door element. The amount of the position offset in the open position or in the closed position of the vehicle door element can be zero in the end region.

The magnitude of the position offset in relation to a travel path of the vehicle door element can be variable in such a way that an amount of the position offset at least substantially remains the same over a central region of the travel path, which extends between an initial region and an end region of the travel path.

The magnitude of the position offset can have a steady course along the travel path of the vehicle door element.

The value of the position offset can be variable in dependence on the determined adjustment position of the first drive. The determined adjustment position of the first drive can refer to the position of the vehicle door element.

The first drive can be connected to an upper region of the vehicle door element, and the second drive can be connected to a lower region of the vehicle door element. Furthermore, the vehicle door element can be shiftable between the open position and the closed position at least substantially horizontally.

The vehicle door system can include at least one coupling element which releasably connects the second drive to the vehicle door element. The vehicle door system can be configured to release the coupling element when the vehicle door element is in the open position and/or in the closed position.

The vehicle door system can include a processor unit and at least one detection device, which is configured to detect a measurement quantity that refers to a state of at least one of the vehicle door element, the first drive, and the second drive. The processor unit can be configured to change the stored position offset at least partly on the basis of the detected measurement quantity and store the changed position offset.

The at least one detection device can comprise a current consumption detection device which is configured to detect a current consumption of the first drive and of the second drive. Furthermore, the processor unit can be configured to change the stored position offset at least partly on the basis of the detected current consumption.

The at least one detection device can comprise a position or movement detection device which permits to determine a movement of the vehicle door element as a result of a release of the coupling element. The processor unit can be configured to change the stored position offset at least partly on the basis of the determined movement of the vehicle door element.

The vehicle door system can include a capacitive anti-pinch protection device.

According to another aspect, there is described another passenger transport system. The passenger transport system comprises a vehicle door system according to any of the preceding claims.

According to another aspect, there is described a method for controlling a vehicle door system. The vehicle door system is provided for reversibly closing a body opening on a vehicle and comprises at least one vehicle door element and a drive device with at least one first drive and at least one second drive for automatically moving the vehicle door element between an open position and a closed position of the vehicle door element. The method comprises controlling, by means of a control device of the vehicle door system, the drive device according to a master-slave relationship, in such a way that the second drive at least partly is controlled on the basis of an assumed adjustment position of the first drive, wherein the assumed adjustment position of the first drive is composed at least of a determined adjustment position of the first drive and a stored position offset, and the position offset has a magnitude variable in dependence on a position of the vehicle door element.

Further details, objects and advantages of the invention will become clear from the drawings and the detailed description.

In the drawings:

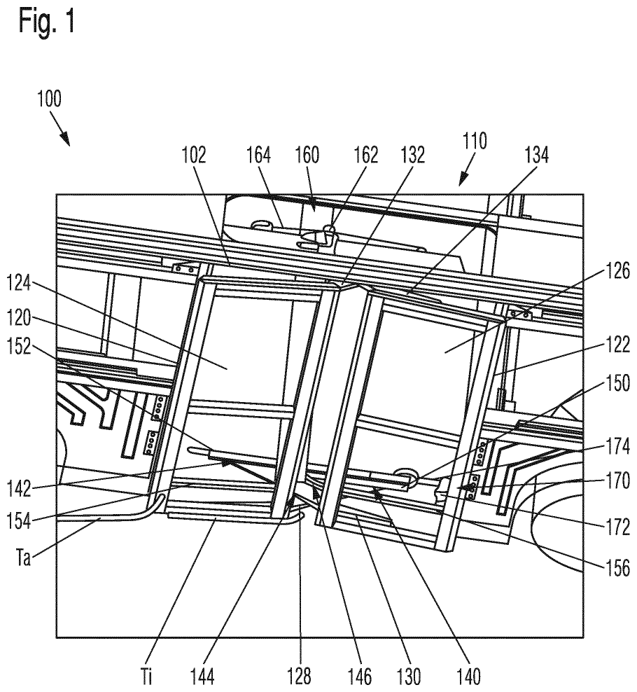

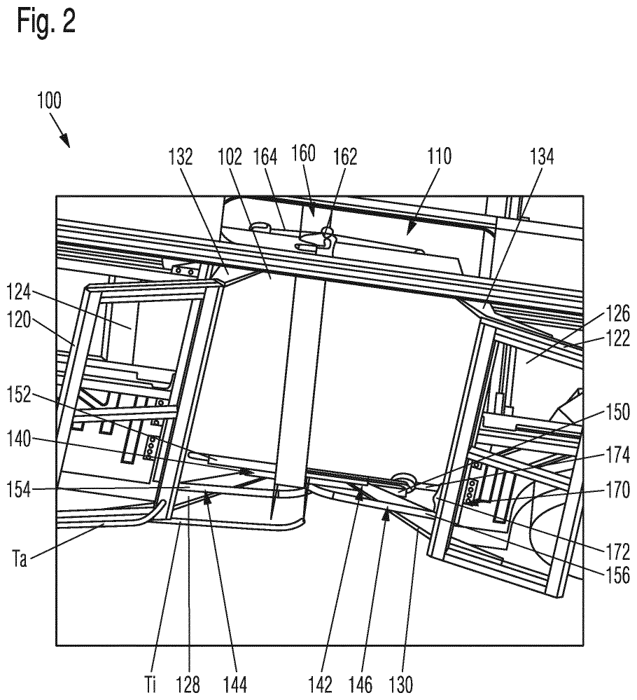

FIGS. 1 and 2 show schematic representations of a passenger transport system with a vehicle door system in various positions according to an exemplary embodiment;

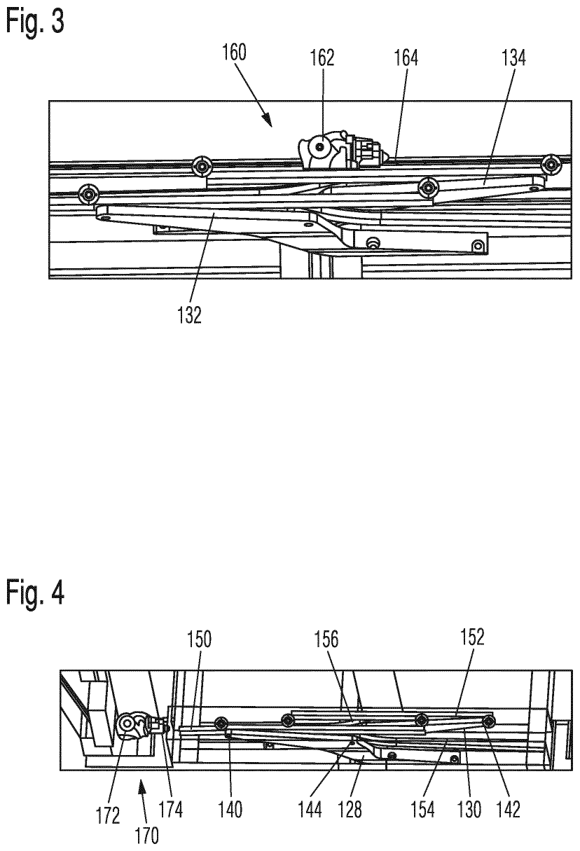

FIG. 3 shows a schematic representation of an upper section of the vehicle door system of FIG. 1;

FIG. 4 shows a schematic representation of a lower section of the vehicle door system of FIG. 1;

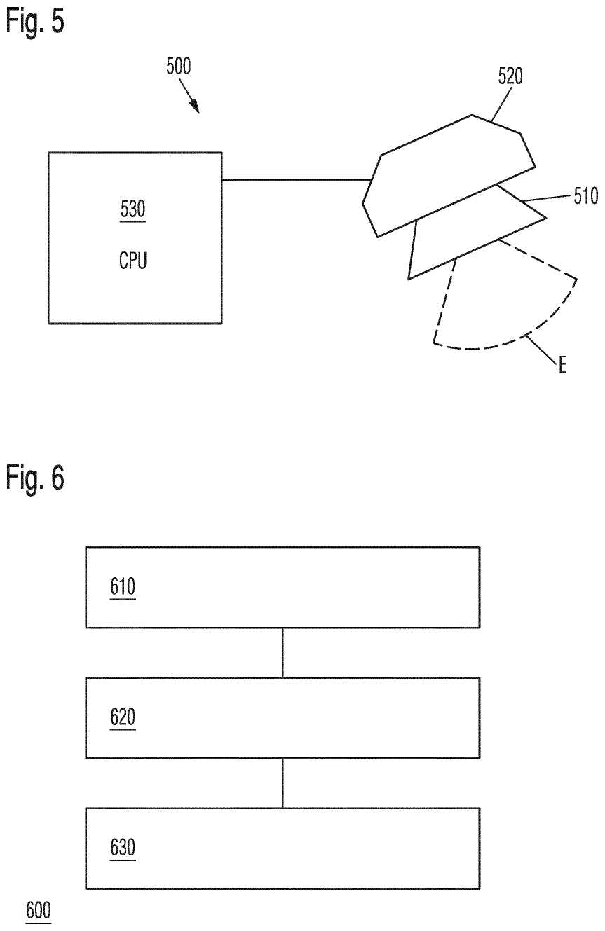

FIG. 5 shows a schematic representation of a sensor device according to another exemplary embodiment;

FIG. 6 shows a flow diagram of a method for operating a sensor device for a vehicle door system according to another exemplary embodiment;

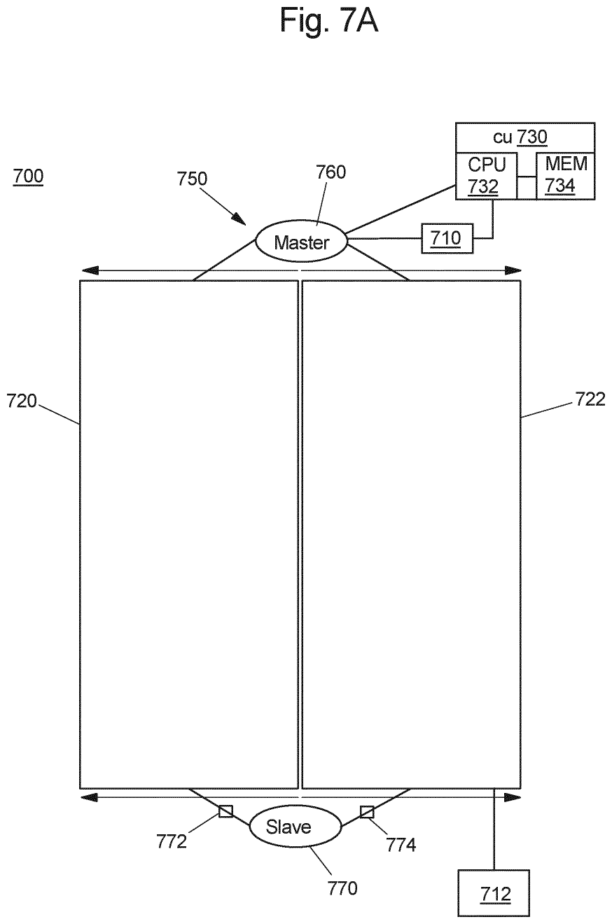

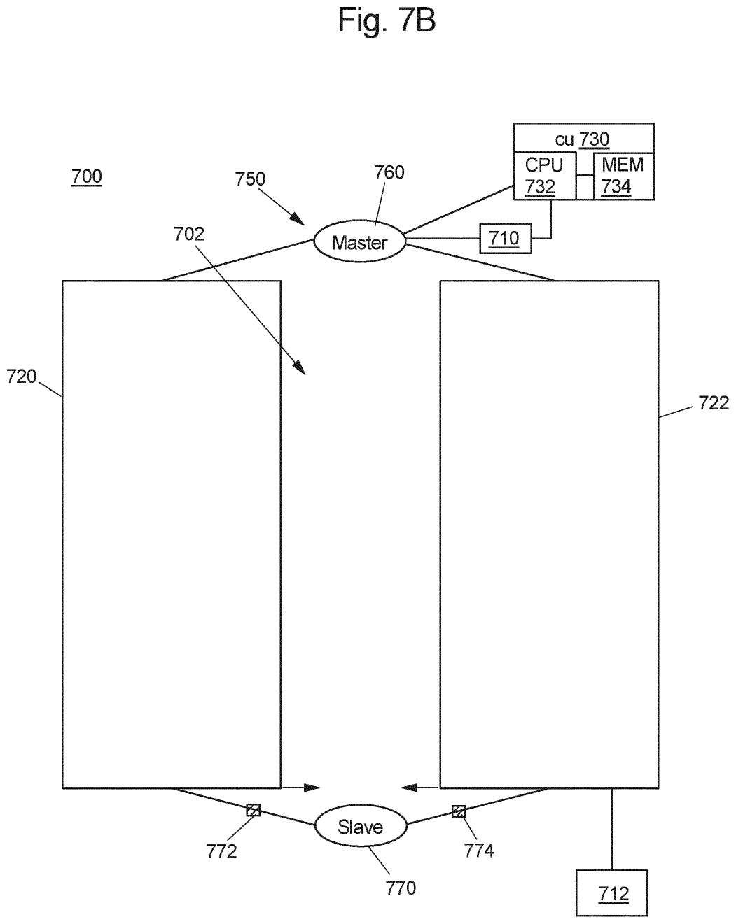

FIGS. 7A and 7B show schematic representations of a vehicle door system in various positions according to another exemplary embodiment;

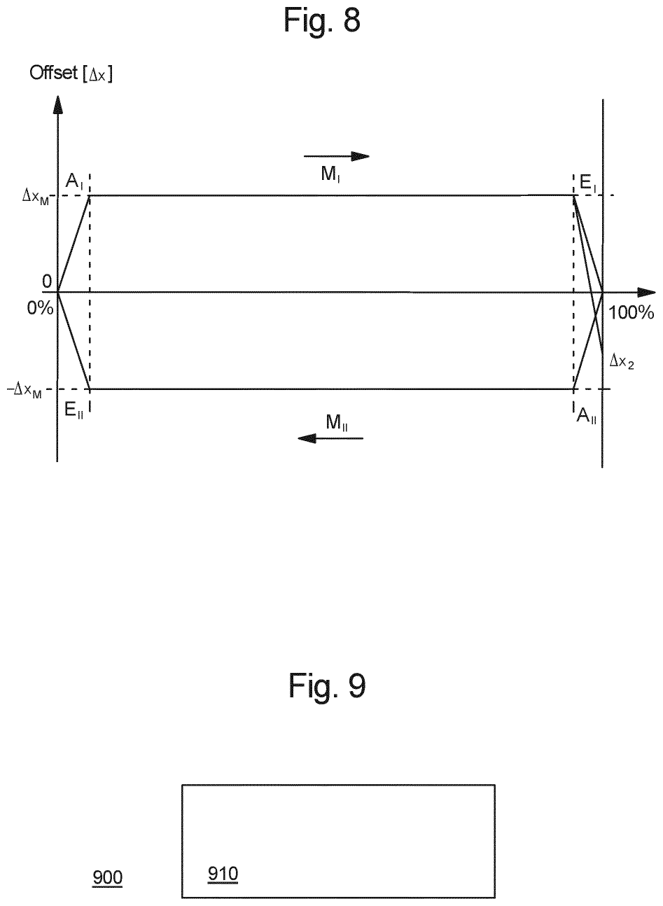

FIG. 8 shows a schematic course of a variable position offset in dependence on a position of a vehicle door element; and

FIG. 9 shows a flow diagram of a method for controlling a vehicle door system.

FIG. 1 shows a perspective view of a section of a passenger transport system 100. The section in particular shows the area of a body opening 102 of the passenger transport system 100, which in the illustrated example corresponds to a side door. For reversibly closing the body opening 102 a vehicle door system 110 is provided. The vehicle door system 110 comprises two vehicle door elements 120, 122 which are arranged similar to a double sliding door. For automatic opening and closing, one drive 160, 170 each with one electric motor 162, 172 each is provided in the upper and in the lower region of the vehicle door system 110, each of which can exert a tensile force on each of the vehicle door elements 120, 122 via a Bowden cable 164, 174 selectively in the opening or closing direction of the respective vehicle door element 120, 122.

The vehicle door elements 120, 122 are formed and arranged approximately mirror-symmetrically. For reasons of simplicity, the following description relates to only one (120) of the vehicle door elements. The following explanations correspondingly apply for the other vehicle door element 122. The vehicle door element 120 comprises a door leaf 124 at whose upper and lower edges a guide arm 128, 132 each is mounted. Each of the guide arms 128, 132 is rigid with respect to the door leaf 124. The vehicle door element 124 is connected to the passenger transport system 100 via the guide arms. The guide arms are mounted in guide rails 150, 154 of the vehicle door system 110, which are mounted on the passenger transport system 100 in the bottom region and in an upper region of the vehicle door system 110. The guide rails 150, 154 in the bottom region and corresponding guide rails (not shown) in the upper region provide for shifting the vehicle door element 120 between a closed position, in which the vehicle door element 120 partly closes the body opening 102, and an open position. The following description relates to the lower guide arm 128 and its bearing in the guide rails 150, 154 in the bottom region of the passenger transport system 100. The bearing of the upper guide arm 132 of the vehicle door element 120, which is not shown in FIG. 1, is configured analogously. Therefore, the following explanations correspondingly apply for the upper bearing of the vehicle door element 120. The guide arm 128 is mounted in two guide rails 150, 154. In a vehicle-side portion, the guide arm 128 therefor includes connecting means 140, 144 which permit a shiftable connection to the guide rails 150, 154. The connecting means 140, 144 for example comprise a roller bearing and/or a carriage.

The guide arm 128 is mounted with a door-side portion close to an inner boundary of the door leaf 124, i.e. a boundary pointing in the closing direction of the vehicle door element 120. The guide arm 120 also is designed such that it protrudes beyond the inner boundary of the door leaf 124 in the closing direction. A first bearing of the guide arm 128 by means of first connecting means 140 on a first guide rail 150 is arranged on the guide arm 128 such that it likewise is disposed in a position protruding beyond the inner boundary of the door leaf 124. At a distance from the first connecting means 140 a second connecting means 144 is arranged on the guide arm 128. The second connecting means 144 effects a shiftable connection of the guide arm 128 to a second guide rail 154.

The illustrated bearing of the guide arm 128 in the guide rails 150, 154 permits shifting of the vehicle door element 120 in a direction of displacement which in the illustrated example extends substantially parallel to the vehicle direction. At the same time, the bearing in two guide rails 150, 154 by connecting means 140, 144 which are arranged spatially apart from each other, due to a suitable course of the guide rails 150, 154 relative to each other, permits to effect a swivel movement of the vehicle door element 120, which is superimposed on the displacement. The positioning at least of the first connecting means 140 protruding beyond an inner boundary of the door leaf 124 increases an achievable swivel path of the door leaf 124 with respect to an outer boundary of the passenger transport system 100. This is advantageous, for example, to provide for swiveling of the door leaf 124 past a wheel area of the passenger transport system 100. Due to the swivel movement superimposed on the displacement, a center of gravity of the vehicle door element 120 on opening also moves away from the passenger transport system 100 towards the outside. In a passenger transport system 100 with tilting technology, for example, an energy expenditure required for opening the vehicle door system 110 is reduced thereby. In some examples, the same also applies for subsequent closing of the vehicle door system 110 after the passenger transport system 100 is tilted back. In the functions described above, a lever effect of the guide arms also is usable advantageously.

At the lower edge of the vehicle door element 120, trajectories Ta, Ti are shown in FIG. 1. Said trajectories correspond to the movements of the lower corners of the door leaf 124 at its inner boundary, Ti, and its outer boundary, Ta. From the illustrated trajectories, the inner boundary Ti extends substantially parallel to the direction of displacement and substantially parallel to the first guide rail 150. The trajectory Ta of the outer boundary of the door leaf 124 on the other hand describes an outwardly pointing course according to the superimposed swivel movement.

This is effected by a corresponding course of the second guide rail 154, which at least sectionally is non-parallel and in the illustrated example also sectionally curved with respect to the course of the first guide rail 150.

For automatically moving the guide arm 128 in the guide rails 150, 154 a drive 170 is provided. An electric motor 172 of the drive 170 acts on a Bowden cable 174. The Bowden cable 174 is attached to a carriage of the first connecting means 140 and thus transmits a tensile force to the guide arm 128 in the region of its first bearing in the first guide rail 150. Due to the rigid arrangement of the guide arm 128 on the door leaf 124 and that of the first and second guide rails 150, 154 relative to each other, the vehicle door element 120 in general follows the specified travel path according to the described complex movement when the first bearing is moved. This is advantageous with respect to vehicle door systems of a different design in order to generate complex or superimposed movements, which for this purpose provide several drives. In the described way, the vehicle door system 110 permits an easier realization and an energy-saving operation.

The provision of separate drives 160, 170 in the upper and in the lower region of the vehicle door system 110 also allows to omit a mechanical transmission of the driving force between the upper and the lower guide arm 120, 130 of each of the vehicle door elements 120, 122, as in conventional swivel sliding doors it is often effected by means of a rotary column. In the vehicle door system 110, a reduction of the usable space by one or more rotary columns hence is avoided. Rotary columns also are of torsion-resistant and often correspondingly heavy design. Due to the omission of rotary columns, the vehicle door system 110 on the other hand provides for a lighter construction.

As shown in FIG. 1, the vehicle door system 110 is configured as a double door. What has been said above, however, also applies for deviating examples in which only one vehicle door element 120 is provided, which completely closes the body opening 102. Due to the extension of the guide arm 128 beyond the inner boundary of the door leaf 124 and the corresponding design of the lower guide arm 130 of the opposite vehicle door element 122, the design as a double door requires to arrange the guide arms 128, 130 offset in height relative to each other. In the closed position of the vehicle door system 110, the guide arms 128, 130 overlap. Such an overlapping, nested arrangement also promotes a compact and stable construction of the vehicle door system 110.

Even in the design as double door, a single drive 170 in the bottom area is sufficient for driving both guide arms 128, 130. This is possible due to a suitably chosen course of the Bowden cable 174. The same applies for the drive 160 in the upper region of the vehicle door system 110. This permits a simple and energy-saving realization of the drive also in the configuration as a double door. The upper drive 160 and the lower drive 170 for example can be actuated in a synchronized way via a master-slave relationship.

FIG. 2 shows the passenger transport system 100 with the vehicle door system 110 in a completely open position of the vehicle door elements 120, 122. What can be seen here is the position of each of the vehicle door elements 120, 122 protruding from the passenger transport system 100 and pivoted corresponding to the trajectories Ta, Ti. There is also shown the non-parallel and, near the closed position of the respective vehicle door element 120, 122, sectionally curved path of the second guide rails 154, 156.

FIG. 3 shows a detail section of the vehicle door system 110 in the region of its upper bearing in the closed position of the vehicle door system 110. There is shown the overlapping arrangement of the guide arms 132, 134. There is also shown the electric motor 162 which jointly drives the guide arms 132, 134 via the Bowden cable 164.

FIG. 4 shows a detail section of the vehicle door system 110 in the region of its lower bearing. The perspective shown corresponds to a view in the closed position of the vehicle door system 110 and with the vehicle floor removed. Corresponding to FIG. 3, the overlapping arrangement of the guide arms 128, 130 is shown as well as the connection of the first connecting means 140, 142 to the respectively associated first guide rail 150, 152 and the connection of each of the second connecting means 144, 146 to the respectively associated second guide rail 154, 156. There is furthermore shown the lower drive 170 with electric motor 172 and Bowden cable 174.

Schematically and by way of example, FIG. 5 shows a sensor device 500 for a vehicle door system, for example for the vehicle door system 110 as described above. The sensor device 500 comprises a sensor unit 510 with a directional detection area E. The sensor unit 510 is configured to detect the presence of an object and/or a person in the detection area. In addition, the sensor unit 510 is mounted on an adjusting device 520. The adjusting device 520 allows a position of the sensor unit 510 to be changed in such a way that an orientation of the detection area E of the sensor unit 510 can be changed. The sensor device 500 also comprises a control unit 530. The control unit 530 is functionally connected to the adjusting device 520 in order to actuate the same and thus change an orientation of the detection area E. As part of a vehicle door system, the control unit 530 also is configured to actuate the adjusting device 520 in dependence on a position of one or more automatically adjustable vehicle door elements of the vehicle door system, such as for example one of the vehicle door elements 120, 122.

On opening and on closing, as described above, each of the vehicle door elements 102, 122 follows a complex movement in which for example shifting and swivel movements are superimposed. Especially in passenger transport systems 100 which operate without any operating personnel, a precise and reliable monitoring of hazardous areas, such as the travel path of an automatic door, is necessary to avoid collisions. Complex movements render corresponding monitoring more difficult, as a hazardous area likewise changes with respect to the moving part due to its variable movement behavior. In this respect, the sensor device 500 is advantageous, as it permits an adaptation of the detection area to the changing hazardous area, in particular in dependence on a position of a vehicle door element 120, 122 on its travel path.

In some examples, a sensor device 500 is mounted on a vehicle door element 120 and monitors the resulting hazardous area on opening or closing of the vehicle door element 120. Depending on the position of the vehicle door element 120 and its imminent driving or swiveling behavior specified by the movement, the control unit 530 controls the adjusting device 520 in such a way that the hazardous area each lies in the detection area E of the sensor unit 510.

In some examples, the sensor device 500 is configured such that in the closed and/or completely open position of the vehicle door element 120, i.e. when there is no hazardous area, the adjusting device 520 moves into a position recessed in the vehicle door element 120. In this way, the risk of a damage of the sensor device 500 due to inadvertent or willful collisions is reduced. At the same time, a risk of injury for passers-by in this way is reduced by the sensor device 500.

The sensor unit 510 for example is a radar sensor.

FIG. 6 shows a flow diagram of a method for operating a sensor device for a vehicle door system as described above. In particular, the method 600 is suitable for operating the sensor device 500 as part of the vehicle door system 110. The method 600 initially comprises determining a position of the vehicle door element by means of the control unit. The control unit for example is an electronic control unit of the vehicle, step 610. Subsequently, the generation of a control signal for controlling the adjusting device is effected by means of the control unit and in dependence on the determined position of the vehicle door element, step 620. The control signal thus generated subsequently is output by the control unit to the adjusting device, step 630.

FIG. 7 schematically shows a vehicle door system 700 according to another example. With respect to its basic components and their mode of operation, the vehicle door system 700 for example is a vehicle door system as described above. In particular, the vehicle door system 700 comprises a first vehicle door element 720 and a second vehicle door element 722, which are horizontally shiftable for reversibly closing a body opening. The vehicle door system 700 also comprises a drive device 750 for automatically actuating the vehicle door elements 720, 722. In the example shown, said drive device has a first drive 760 in the upper region of the vehicle door system 700, and a second drive 770 in the lower region of the vehicle door system 700. The first drive 760 is configured to exert a driving force on an upper part of each of the vehicle door elements 720, 722. Correspondingly, the second drive 770 is configured to exert a driving force on a lower part of each of the vehicle door elements 720, 722. The drive device 750 can be controlled by means of a control unit 730 of the vehicle door system 700.

The drives 760, 770 are operated in a master-slave relationship to each other. A setpoint position for the slave drive, which in the present example is the second drive 770, is determined with reference to an adjustment position of the master drive, in the illustrated example of the first drive 760. For example, the first drive 760 is controlled by the control unit 730 in order to move the vehicle door elements 720, 722. A movement or a changed position of the vehicle door elements 720, 722 for example is detected by sensors, and a corresponding control signal for the second drive 770 is determined by the control unit 730 with reference to the detected movement or position and output to the second drive 770. Between the second drive 770 and each of the vehicle door elements 720, 722 a coupling element 772, 772 each is provided for a releasable connection between the second drive 770 and the vehicle door elements 720, 722. In a completely open door position, the same serve to release the second drive 770 from the vehicle door elements 720, 722. In other examples, only one coupling element is provided, arranged for example centrally on the second drive, in order to releasably connect both vehicle door elements 720, 722 to the second drive.

In conventional vehicle door systems, in which drives are operated in a master-slave relationship, disadvantages usually result from a temporally delayed actuation of the slave drive. Such a delay results from the processing time required for determining the adjustment position of the master drive and for determining the control signal for the slave drive with reference to the determined adjustment position of the first drive. Even if such processing time usually is small, there is still obtained an uneven load distribution between the drives.

Especially when starting a vehicle door element from a standing position, for example a completely closed or open position, a load initially completely acts on the master drive. This results from a higher current consumption and a correspondingly higher heat generation and thus can lead to an early failure of the master drive. In other situations, too, comparable disadvantages result from the fact that the slave drive temporally lags behind the master drive.

To mitigate this problem it is known to apply a position offset to the determined adjustment position of the master drive and determine the control signal for the slave drive with reference to the position offset applied to the adjustment position of the master drive. The position offset ideally is chosen such that it at least partly compensates the time delay resulting from the generation of the control signal for the slave drive. Hence, for determining the control signal for the slave drive an adjustment position of the master drive is assumed, which precedes the determined adjustment position of the master drive in the traveling direction of the vehicle door element. For example, what is assumed as an adjustment position of the master drive for generating the control signal for the slave drive is the position which the master drive will have assumed at the moment when the control signal is provided at the slave drive. The position offset for example approximately corresponds to the product of the time delay resulting from the generation of the control signal for the slave drive and a mean traveling speed of the vehicle door element. In other examples, the position offset is chosen differently. Here too, however, the choice of the position offset typically is such that disadvantages resulting from a time delay between master drive and slave drive are reduced.

In known vehicle door systems, the position offset is a value predetermined for the respective system. The same for example is stored as a constant value in a memory unit of the controller which is used for determining the control signal for the slave drive and is applied as an additive constant when determining the control signal for the slave drive.

When using a constant position offset, however, further disadvantages are obtained. When starting a vehicle door element from a rest position, the master drive does not immediately reach the intended traveling speed, but undergoes an acceleration. When the control signal for the slave drive in this case is determined with reference to a position offset, which is chosen on the basis of the mean or final traveling speed of the master drive, an assumed adjustment position of the master drive therefore would be specified for the slave drive when starting the vehicle door element, which is too far ahead of the relevant position of the master drive. This in turn leads to an uneven load distribution between master drive and slave drive, in this case to the detriment of the slave drive.

In addition, when reaching the end of a travel path, for example when the door is completely open, a setpoint position which is beyond the end position would be specified for the slave drive towards the end of the travel. This often leads to the fact that when the door is completely opened, the vehicle door element on the side of the slave drive initially is driven into an overtensioned position. When stopping the drive or decoupling the slave drive from the vehicle door element, for instance by means of the coupling elements 772, 774 in the example of FIG. 7A, this is expressed by the vehicle door elements 720, 722 in the region of the slave drive bouncing back or slumping back from the overtensioned position into a relaxed rest position. This is schematically indicated in FIG. 7B by the arrows in the lower region of the vehicle door elements 720, 722. Such slumping back of the vehicle door element, which often results in undesired shaking of the door, is promoted by the fact that vehicle door elements 720, 722 typically are rigidly guided on the master side, whereas the slave-side guidance has a larger clearance.

Beside the esthetic disadvantage of such bouncing back or slumping of the vehicle door elements, further disadvantages result from the fact that this movement is uncontrolled and an exact position of the vehicle door element on the slave side hence is accidental. This has a disadvantageous effect on functions of the vehicle door system requiring precise knowledge of the position of the vehicle door element. Capacitive anti-pinch protection systems for example usually are calibrated with respect to a master-side position of the vehicle door element. When a closing operation of the vehicle door element subsequently is effected out of a position of the vehicle door element strongly deviating from the calibration position on the slave side, this can lead to errors. For example, approaching the closed position erroneously can be interpreted as a pinching situation, when the vehicle door element on the slave side already is disposed closer to a body part than provided according to the calibration. This in turn can lead to unnecessary and undesired triggering of automatic safety measures, such as for example automatic renewed opening of the vehicle door element.

In many vehicle door elements, a traveling speed also often is not exactly constant even in a middle region of the travel path, but undergoes position-dependent fluctuations. Therefore, a constant position offset leads to an uneven load distribution between the drives also in these cases.

FIG. 7B shows the vehicle door system 700 of FIG. 7A in an open position. The vehicle door elements 720, 722 each are shifted to the side, and the body opening 702 is cleared between the vehicle door elements 720, 722. The coupling elements 772, 774 also are in an open position. As is illustrated by the arrows in the lower region of the vehicle door elements 720, 722, the release of the coupling elements 772, 774 effects slumping of the vehicle door elements 720, 722 in their lower region at least with a non-ideally chosen position offset.

To avoid the above-described disadvantages of conventional vehicle door systems, the vehicle door system 700 is configured to apply a position offset to a determined adjustment position of the first drive 760, which is stored in a memory device 734 of the control unit 730 and has a magnitude variable with respect to a position of the vehicle door element 720, 722. FIG. 8 by way of example shows a position offset Δx which has a position-dependent value. In the example shown, the position offset Δx is variable with respect to a point in the range from a closed position (0%) of the vehicle door element to a completely open position (100%) of the vehicle door element. In the diagram, a position offset in the opening direction of the door is plotted as a positive value and in the closing direction of the door as a negative value. In other examples, the position offset stored in the memory device 734 additionally or alternatively is stored with respect to a travel path, for example proceeding from any rest position of the vehicle door element between a closed position and an open position. The following explanations correspondingly also apply for a travel-path-related position offset or can be transferred to the same in a way easily recognizable for the skilled person.

As is shown in FIG. 8, a maximum offset value is not applied immediately on opening of the vehicle door element out of the closed position. Instead, the position offset has a smaller magnitude in an initial region A_{I} than in a succeeding region M_{I}. An uneven load distribution between master drive and slave drive during an acceleration of the master drive, as described above for conventional systems, can be reduced in this way. In the example of FIG. 8, the position offset Δx in the initial region A_{I} in particular describes a rising flank, for example according to a rising traveling speed of the master drive. In the illustrated example, the position offset moreover starts with an initial value of zero. In other examples, initial values deviating therefrom are used, wherein here, too, the position offset in the initial region A_{I} however is smaller than in at least one succeeding region of the travel path.

In the middle region M_{I} of the travel path in the opening direction, the stored position offset Δx constantly has its highest value. For example, the same approximately corresponds to the product of the traveling speed of the vehicle door element with retracted first drive 760 and the time period required to provide the control signal to the second drive 770. In the example shown, the position offset is constant in the middle region M_{I}. In other examples, as described below, an uneven course of the position offset however is also applicable in the middle region M₁.

When approaching the open position in an end region E_{I}, lowering of the position offset is effected. In this way, a setpoint position extending beyond the end position of the vehicle door element is reduced for the second drive 770, which otherwise would manifest itself in an overtensioned position of the vehicle door element in its lower region and consequently in a bouncing back or slumping of the vehicle door elements. In the example shown, the position offset is lowered to zero when the vehicle door element reaches the completely open position on the master side. Slave-side overtensioning due to the position offset as compared to the master-side position thus is avoided. In other examples, however, the reduction of the position offset in the end region E_{I} also can effect a value of the position offset different from zero. For example, in some vehicle door systems an offset Δx₂ different from zero, for example even directed against the traveling direction, as is indicated by the dotted diagonal in the right part of the diagram of FIG. 8, is advantageous in some vehicle door systems due to the guidance of the vehicle door element with a clearance in its lower region, in order to approach a position of the vehicle door element as free from tension as possible in its lower region, before the corresponding coupling element 772, 774 is released. Undesired shaking of the vehicle door element on release of the coupling 772, 774 thus can be minimized in a way specific for the vehicle door system 700.

According to FIG. 8, what has been described above for an opening process of the vehicle door also is applicable in the closing direction of the vehicle door element. When starting the vehicle door element in the closing direction, the amount of a position offset preceding in the closing direction, i.e. negative in the diagram, increases up to a value −Δx within an initial region A_{II}. Correspondingly, the amount of the applied position offset is reduced when approaching the closed position, i.e. in the diagram in the positive direction.

In some examples of the vehicle door system 700 a position-dependent position offset is stored in the memory device 734 as a constant characteristic according to what has been explained above. The course of the position offset for example is determined by the manufacturer and specifically for the vehicle door system 700 and is stored in the memory device 734.

In further examples of the vehicle door system 700, an adaptation of the position offset stored in the memory device 734 also is possible even subsequently during the operation of the vehicle door system 700. In particular, some examples of the vehicle door system 700 are configured for an automatic adaptation of the position offset and for storing a position offset adapted in this way. This for example permits an optimization of the position-dependent position offset corresponding to an individual type of the respective vehicle door system. Moreover, a for example wear-related change, e.g. of a clearance in the guidance of a vehicle door element 720, 722, can be taken into account in this way, wherein an optimized position offset is provided at any time.

For the described purpose of an automatic adaptation of the position offset, detection devices 710, 712 of the vehicle door system 700 are provided. Each of the detection devices 710, 712 serves to detect a measurement quantity which indicates a state of the respective vehicle door element 720, 722, of the first drive 760 and/or of the second drive 770. A processor unit 732 of the control unit 730 is configured to change the stored position offset on the basis of the detected measurement quantity and store the position offset thus changed in the memory device 734.

One of the detection devices 710, 712 is a current consumption detection device 710. The same is configured to detect a current consumption of the first drive 760 and of the second drive 770. With reference to the detected respective current consumption it is possible to infer an uneven load distribution between the first drive 760 and the second drive 770 by comparing by means of the processor unit 732. By varying the position offset at the corresponding position of the vehicle door element during subsequent operating procedures of the vehicle door system 700, an optimum position offset can be determined, at which for example a difference of the current consumptions is minimal. During several opening and closing operations of the vehicle door system 700, an ideal course of the offset can be iteratively learned and stored for the entire travel path with reference to the respectively detected measurement quantities and position offset values varied on the basis of the same.

Moreover, in the described way an optimized position offset can also be achieved for various positions in the respective middle region M_{I}, M_{II} at a variable traveling speed of the vehicle door element 720, 722 within this area.

Another one of the detection devices 710, 712 is a movement detection device 712. The same is configured to detect a movement, in particular a bouncing back or slumping back of a respective vehicle door element 720, 722. This permits the detection of undesired movements of the vehicle door element 720, 722, which occurs on opening of the coupling elements 732, 734 due to the offset. The learning and storing of a position offset optimized with respect to such undesired movements, for example in an end region E_{I}, E_{II} of the respective travel path, is effected analogously to the above-described optimization of the position-dependent position offset on the basis of the measurement quantities detected by means of the current consumption detection device 710.

When an adaptation of the position offset is effected after a detected bouncing back of the vehicle door element, as described here, it is also advantageous to recalibrate position-dependent functions of the vehicle door system 700, such as for example a capacitive anti-pinch protection system, on the basis of the adapted position offset.

FIG. 9 schematically shows a block diagram of a method 900 for controlling a vehicle door system. The vehicle door system serves for reversibly closing a body opening on a vehicle and comprises at least one vehicle door element and a drive device with at least one first drive and at least one second drive for automatically moving the vehicle door element between an open position and a closed position. For example, this is the vehicle door system 700 as described in connection with FIGS. 7A and 7B. The method 900 comprises controlling, by means of a control device of the vehicle door system, the drive device according to a master-slave relationship, in such a way that the second drive is at least partly controlled on the basis of an assumed adjustment position of the first drive, step 910. The assumed adjustment position of the first drive is composed at least of a determined adjustment position of the first drive and a stored position offset. The position offset has a magnitude variable in dependence on a position of the vehicle door element.

### LIST OF REFERENCE NUMERALS

100—passenger transport system

102, 702—body opening

110, 700—vehicle door system

120, 122, 720, 722—vehicle door element

124, 126—door leaf

128, 130, 132, 134—guide arm

140, 142—first connecting means

144, 146—second connecting means

150, 152—first guide rail

154, 156—second guide rail

160, 170, 760, 770—drive

162, 172—electric motor

164, 174—Bowden cable

500—sensor device

510—sensor unit

520—adjusting device

530, 730—control unit

600—method

610, 620, 630—method steps

710, 712—detection device

732—processor unit

734—memory device

750—driving device

772, 774—coupling element

E—detection area

Ta, Ti—trajectories

A_{I}, A_{II}, M_{I}, M_{II}, E_{I}, E_{II}—travel path region

Δx, Δx₂—position offset

1. A vehicle door element (120, 122) for reversibly closing at least a part of a body opening (102) on a vehicle (100), comprising a door leaf (124, 126) and at least one guide arm (128, 130, 132, 134) which includes a door-side portion and a vehicle-side portion, wherein the door-side portion of the guide arm (128, 130, 132, 134) is mounted on the door leaf (124, 126) and the vehicle-side portion of the guide arm (128, 130, 132, 134) includes connecting means (140, 142, 144, 146) which are configured for shiftably connecting the vehicle door element (120, 122) to the vehicle (100),
characterized in that
the connecting means (140, 142, 144, 146) comprise at least one first connecting means (140, 142) which is configured for shiftable connection to a first guide rail (150, 152) of a vehicle door system (110) of the vehicle (100), and at least one second connecting means (144, 146) which is configured for shiftable connection to a second guide rail (154, 156) of the vehicle door system (110) of the vehicle (100).

2. The vehicle door element according to claim 1, characterized in that the guide arm (128, 130, 132, 134) is rigid with respect to the door leaf (124, 126), and the first connecting means (140, 142) and the second connecting means (144, 146) are spaced apart from each other along a direction of displacement of the vehicle door element (120, 122).

3. The vehicle door element according to claim 1 or 2, characterized in that in the region of the first connecting means (140, 142) the guide arm (128, 130, 132, 134) extends parallel to the direction of displacement beyond a boundary of the door leaf (124, 126).

4. The vehicle door element according to claim 3, characterized in that in the region of the first connecting means (140, 142) the guide arm (128, 130, 132, 134) extends in a closing direction of the vehicle door element (120, 122) beyond the boundary of the door leaf (124, 126).

5. The vehicle door element according to any of the preceding claims, characterized in that the vehicle door element (120, 122) comprises two guide arms (128, 130, 132, 134) which are arranged on opposite sides of the door leaf (124, 126).

6. A vehicle door system (110) comprising:
at least one vehicle door element (120, 122) according to any of the preceding claims, and
at least one first guide rail (150, 152) for shiftable connection to a first connecting means (140, 142) of the vehicle door element (150, 152) and at least one second guide rail (154, 156) for shiftable connection to a second connecting means (144, 146) of the vehicle door element (120, 122),
characterized in that
the first guide rail (150, 152) extends substantially parallel to a direction of displacement of the vehicle door element (120, 122), and the second guide rail (154, 156) includes at least one portion non-parallel to the direction of displacement.

7. The vehicle door system according to claim 6, characterized in that the first connecting means (140, 142) comprises a carriage which is shiftably arranged on the first guide rail (150, 152).

8. The vehicle door system according to claim 7, characterized in that the vehicle door system (110) furthermore comprises at least one drive (160, 170) with at least one Bowden cable (164, 174), wherein the Bowden cable (164, 174) is attached to the carriage.

9. The vehicle door system according to claim 8 with at least one vehicle door element according to claim 5, characterized in that the vehicle door system (110) comprises at least two drives (160, 170), each of which is provided for automatically moving the at least one guide arm each on one of the opposite sides of the door leaf (124, 126).

10. The vehicle door system according to any of claims 6 to 9, characterized in that the vehicle door system (110) comprises at least two vehicle door elements (120, 122) which are arranged with opposite closing directions.

11. The vehicle door system according to claim 10, characterized in that in the closed position of the vehicle door elements (120, 122) guide arms (128, 130, 132, 134), which are associated to different vehicle door elements (120, 122) and which are arranged on the same side of the respective door leaf (124, 126) with respect to the body opening (102), overlap each other.

12. The vehicle door system according to claim 10 or 11 in conjunction with claim 8, characterized in that the drive (160, 170) is configured to drive the carriages of several guide arms (128, 130, 132, 134), which are arranged on the same side with respect to the body opening (102), at the same time.

13. The vehicle door system according to any of claims 6 to 12, characterized by at least one sensor device (500) comprising:
a sensor unit (510) which includes a directional detection area (E) and is configured to detect the presence of an object in the detection area (E),
an adjusting device (520) which is arranged on the sensor unit (510) and is configured to adjust a position of the sensor unit (510) in such a way that an orientation of the detection area (E) of the sensor unit (510) is changed thereby, and
a control unit (530) which is configured to control the adjusting device (520) in dependence on the position of the vehicle door element (120, 122).

14. A sensor device (500) for a vehicle door system (110) comprising:
a sensor unit (510) which includes a directional detection area (E) and is configured to detect the presence of an object in the detection area (E),
an adjusting device (520) which is arranged on the sensor unit (510) and is configured to adjust a position of the sensor unit (510) in such a way that an orientation of the detection area (E) of the sensor unit (510) is changed, and
a control unit (530) which is configured to control the adjusting device (520) in dependence on the position of at least one vehicle door element (120, 122) of the vehicle door system (110).

15. The sensor device according to claim 14, characterized in that the sensor unit (510) and the adjusting device (520) are configured for arrangement on the vehicle door element (120, 122).

16. The sensor device according to claim 15, characterized in that the control unit (530) is configured to control the adjusting device (520) in such a way that in a closed position and/or in a completely open position of the vehicle door element (120, 122) the sensor unit (510) is in a recessed position in the vehicle door element (120, 122).

17. The sensor device according to any of claims 14 to 16, characterized in that the vehicle door system (110) is configured such that the vehicle door element (120, 122) is shiftable between a closed position and a completely open position along a non-linear travel path, and the control unit (530) is configured to control the adjusting device (520) in such a way that the detection area (E) of the sensor unit (510) comprises a hazardous area variable in dependence on the position of the vehicle door element (120, 122) corresponding to the travel path.

18. The sensor device according to claim 17, characterized in that the control unit (530) furthermore is configured to determine a position of the detection area (E) with respect to the vehicle door system (110) in dependence on the position of the vehicle door element (120, 122).

19. A passenger transport system (100), comprising a vehicle door element according to any of claims 1 to 5, a vehicle door system according to any of claims 6 to 13, and/or a sensor device according to any of claims 14 to 18.

20. A method (600) for operating a sensor device (500) for a vehicle door system (110), the vehicle door system (110) comprising:
a sensor unit (510) which includes a directional detection area (E) and is configured to detect the presence of an object in the detection area (E),
an adjusting device (520) which is arranged on the sensor unit (510) and is configured to adjust a position of the sensor unit (510) in such a way that an orientation of the detection area (E) of the sensor unit (510) is changed, and
a control unit (530) which is configured to control the adjusting device (520) in dependence on the position of at least one vehicle door element (120, 122) of the vehicle door system (110),
the method comprising:
determining (610), by means of the control unit (530), a position of the vehicle door element (120, 122),
generating (620), by means of the control unit (530) and in dependence on the determined position of the vehicle door element (120, 122), a control signal for controlling the adjusting device (520), and
outputting (630), by means of the control unit (520), the control signal to the adjusting device (520).

21. A vehicle door system (700) for reversibly closing a body opening (706) on a vehicle, comprising:
at least one vehicle door element (720, 722),
a drive device (750) with at least one first drive (760) and at least one second drive (770) for automatically moving the vehicle door element (720, 722) between an open position and a closed position of the vehicle door element (720, 722), and
a control device (730) which is configured to control the drive device (750) according to a master-slave relationship in such a way that the second drive (770) at least partly is controlled on the basis of the assumed adjustment position of the first drive (760), wherein the assumed adjustment position of the first drive (760) is composed at least of a determined adjustment position of the first drive (760) and a stored position offset (Δx),
characterized in that
the position offset (Δx) has a magnitude variable in dependence on a position of the vehicle door element (720, 722).

22. A passenger transport system, comprising a vehicle door system according to claim 21.

23. A method (900) for controlling a vehicle door system (700), wherein the vehicle door system (700) is provided for reversibly closing a body opening (706) on a vehicle and comprises at least one vehicle door element (720, 722) and a drive device (750) with at least one first drive (760) and at least one second drive (770) for automatically moving the vehicle door element (720, 722) between an open position and a closed position of the vehicle door element (720, 722), the method comprising;
controlling (910), by means of a control device (730) of the vehicle door system (700), the drive device (750) according to a master-slave relationship in such a way that the second drive (770) at least partly is controlled on the basis of an assumed adjustment position of the first drive (760), wherein the assumed adjustment position of the first drive (760) is composed at least of a determined adjustment position of the first drive (760) and a stored position offset (Δx), and the position offset (Δx) has a magnitude variable in dependence on a position of the vehicle door element (720, 722).
